(19) United States
(12) Patent Application Publication
(10) Pub. No.: US 2004/0121054 A1
(43) Pub. Date: Jun. 24, 2004

(54) Method of preparing food

(76) Inventors: Arthur L. Berrier, Simpsonville, SC (US); Cynthia L. Ebner, Greer, SC (US); Nathanael R. Miranda, Spartanburg, SC (US)

Correspondence Address: Daniel B. Ruble, Sealed Air Corporation, P.O. Box 464, Duncan, SC, 29334, US

(21) Appl. No.: 10/325,285

(22) Filed: Dec. 20, 2002

(51) Int. Cl. C12C 3/04

(52) U.S. Cl. 426/412

(57) ABSTRACT

A method of reheating a cooked food. First, an unperforated package is provided having an internal pressure of less than about 13.7 psia and enclosing a cooked meat. The package comprises a film comprising an inside film layer adjacent the internal space of the package. The inside film layer comprises one or more polymers selected from polyamide and polyester. The cooked meat is heated while enclosed in the unperforated package to an internal meat temperature of above about 100° F. The method is useful in reducing the warmed over flavor effect that may result from reheating the cooked meat.

### BACKGROUND OF THE INVENTION

The present invention relates to preparing food, for example, preparing food by reheating previously cooked meat.

For the convenience of consumers, packaged food may be designed to be placed directly in a microwave or conventional oven to heat or cook the food without first removing the packaging. The consumer thus avoids having to handle the raw product or to clean a container in which the food would have otherwise been placed for cooking or heating. The consumer may also simply dispose of the packaging material after heating or cooking the food.

Packaging that can withstand exposure to the heating and/or cooking environment of a selected type of oven is said to be “ovenable” with respect to that type of oven. To be ovenable with respect to a microwave oven, the packaging should not, for example, include materials such as metals that reflect microwaves to cause arcing or otherwise damage the oven's microwave generation. To be ovenable with respect to a conventional oven, the packaging should, for example, be able in use to withstand exposure to 400° F. air temperature for up to four hours. Packaging that is ovenable both with respect to a microwave oven and a conventional oven is said to be “dual-ovenable.”

Food packaging may be formed by heat sealing thermoplastic film to itself to form a pouch or similar article containing the food. This heat sealing operation typically occurs at the food packager's plant using a heat sealing machine designed for high speed operation. Although there are several variations, generally a heat sealing machine includes a heated seal bar that contacts and compresses the two films to be heat sealed together. Three variables are important in forming a heat seal: 1) the seal bar temperature, 2) the dwell time, and 3) the sealing pressure. The seal bar temperature is the surface temperature of the seal bar. The dwell time is the length of time that the heated seal bar contacts the film to transfer heat from the seal bar to soften at least a portion of the films (e.g., the sealing layers of the films) so that they may be melded together. The sealing pressure is the amount of force that squeezes the films together during this heat transfer. All of these variables interact in completing a successful heat seal.

Because the heat sealing layers for much of the thermoplastic packaging films used in food packaging are based on relatively low-melting polyolefin thermoplastics (or similar melt-temperature thermoplastics), the heat sealing machines present in food packaging plants are often designed and set to operate with a seal bar temperature, a dwell time, and a sealing pressure in a range useful for such materials. This permits the heat sealing machines to operate at high speeds to form strong seals. Such a heat sealing machine may operate at, for example, a seal bar temperature of 290° F., a dwell time of 0.5 seconds, and a sealing pressure of 40 psig.

An existing ovenable packaging material for conventional ovens is a monolayer film based on a blend of nylon 6 with nylon 6,6. However, this film requires a relatively high sealing temperature to effect a useful heat seal. For example, at a sealing pressure of 40 psig and a dwell time of 0.5 seconds, the sealing bar temperature is generally at least about 380° F. Because typical existing heat sealing machines in food packaging plants cannot easily accommodate operation at those conditions, rather than forming a heat seal, a metal clip is typically used to close food packaging based on this film, in which case the resulting food packaging is not dual ovenable. Further, a metal clip is an expensive closure method compared to heat sealing—and limits the use of X-ray examination to check packages for metallic contaminants.

Cooked meat such as cooked red meat may be stored in packaging, and then later reheated by removing the cooked meat from the packaging and heating it in an oven. However, such reheated cooked meat may exhibit an undesirable “warmed-over” flavor. “Warmed-over flavor” is a term of art used to describe an off-flavor that develops soon after cooked meat is exposed to oxygen, and becomes more apparent following reheating of the cooked meat. It would be desirable to reduce the warmed-over flavor effect that occurs when reheating cooked meat.

### SUMMARY OF THE INVENTION

The present invention addresses one or more of the aforementioned problems. A method of preparing food includes the following steps. First, an unperforated package is provided. The internal space inside the package has a pressure of less than about 13.7 psia. A cooked meat is in the internal space of the package. The cooked meat has an internal meat temperature of less than about 100° F. The package comprises a film comprising an inside film layer adjacent the internal space of the package. The inside film layer comprises one or more polymers selected from polyamide and polyester. Subsequent to the providing step, the cooked meat is heated in the internal space of the package to an internal meat temperature of above about 100° F. while the package is in the unperforated state. The method is useful in reducing the warmed over flavor effect that may otherwise result from reheating the cooked meat.

These and other objects, advantages, and features of the invention will be more readily understood and appreciated by reference to the detailed description of the invention and the drawings.

### BRIEF DESCRIPTION OF THE DRAWINGS

FIG. 1 is a representational cross-section of a two-layer film useful in the method of the present invention;

FIG. 2 is a representational cross-section of a film useful in the method of the present invention having at least three layers;

FIG. 3 is a representational cross-section of another film useful in the method of the present invention having at least three layers;

FIG. 4 is a representational cross-section of a film useful in the method of the present invention having at least four layers; and

FIG. 5 is a perspective view of a pouch useful in the method of the present invention.

### DETAILED DESCRIPTION OF THE INVENTION

The method of the present invention includes providing an unperforated package 50 having a cooked meat (not shown) packaged within the internal space of the package. (FIG. 5.) The package comprises a film (e.g., film 10, 20, 30, or 40) having an inside film layer 12 adjacent the internal space of the package. The package is provided with the internal meat temperature of the cooked meat at less than about 100° F. and the pressure of the internal space of the package at less than about 13.7 psia. The cooked meat is subsequently heated to an internal meat temperature of above about 100° F. while the package is in the unperforated state.

### The Film

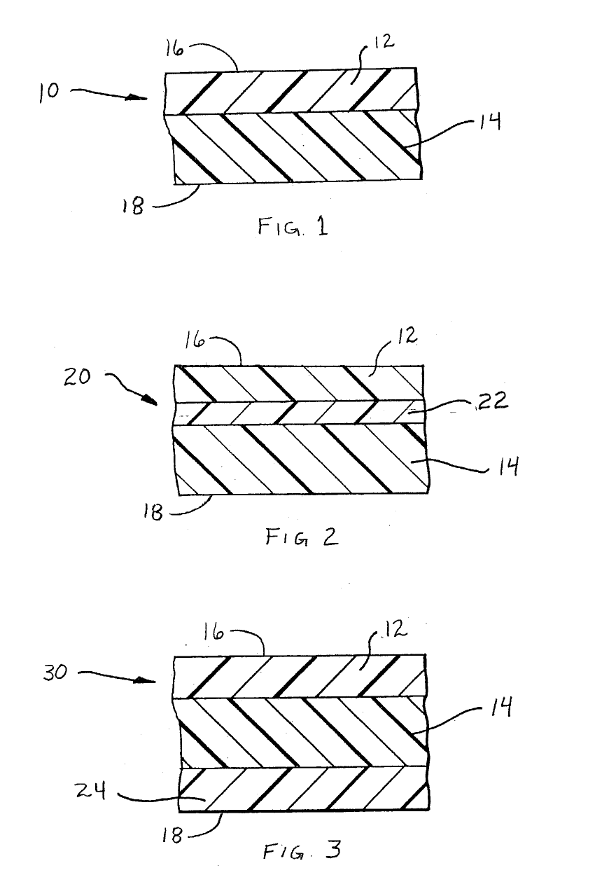

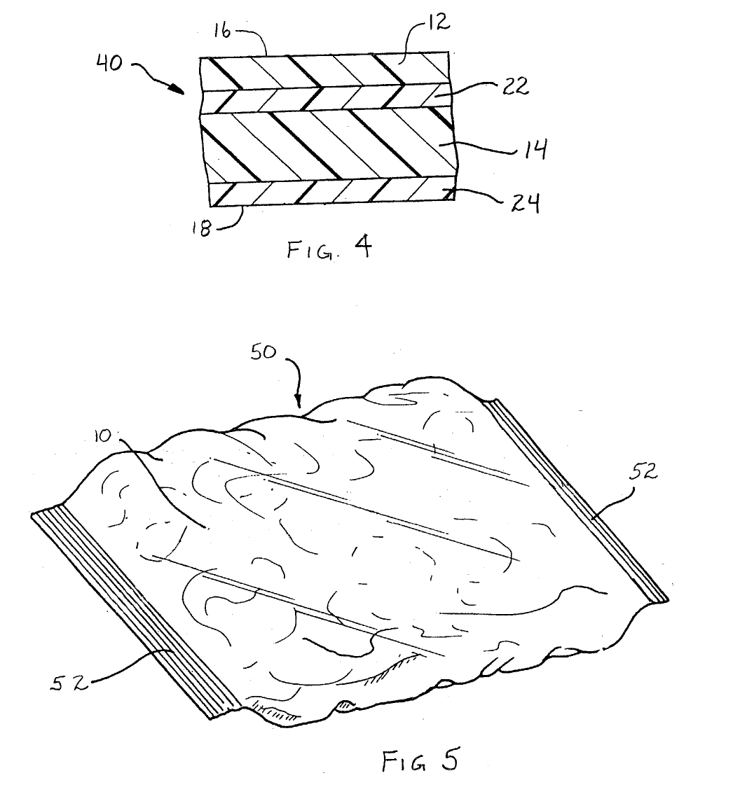

The film comprises an inside film layer 12 adjacent the internal space inside the package. The film may be monolayer (not shown), in which case the first layer 12 is the only layer of the film. The film may comprise at least two layers: first layer 12 and second layer 14. For two-layer film 10 (FIG. 1), first layer 12 forms the first outer surface 16 of the film and second layer 14 forms the second outer surface 18 of film 10 opposite outer surface 16. For a film comprising three or more layers, both the first and second layers 12, 14 may be outer layers forming the outside surfaces of the film 20 (FIG. 2) with one or more additional layers 22 between the first and second layers—or the second layer 14 may form an interior layer of film as shown by film 30 (FIG. 3) with one or more additional layers 24 oriented to the exterior of second layer 14. For a film comprising four or more layers, the second layer 14 may form an interior layer of film as shown by film 40 (FIG. 4) with one or more additional layers 22 between the first and second layers and with one or more additional layers 24 oriented to the exterior of second layer 14.

A useful film may comprise, for example, one layer, two layers, at least 2 layers, at least 3 layers, at least 4 layers, at least 5 layers, from 2 to 4 layers, from 2 to 5 layers, and from 5 to 9 layers. As used herein, the term “layer” refers to a discrete film component which is coextensive with the film and has a substantially uniform composition. Where two or more adjacent layers have essentially the same composition, then these two or more adjacent layers may be considered a single layer for the purposes of this application.

The film may comprise one or more polyamides, one or more polyesters, or a blend of polyamide and polyester in an amount of any of the following ranges based on the weight of the film: at least about 70%, at least about 80%, at least about 90%, at least about 95%, at least about 96%, and at least about 98%. Further, the film may comprise about 100%, may consist of, or may consist essentially of: one or more polyamides, one or more polyesters, or a blend of polyamide and polyester.

The film may comprise less than about any of the following amounts of polyolefin (based on the weight of the film): 20%, 15%, 10%, 5%, 3%, 2%, and 1%; and the amount of polyolefin in the film may range between any two of these values (e.g., from about 2% to about 15%). The film may be substantially free of polyolefin.

The film may comprise less than about any of the following amounts of polyester (based on the weight of the film): 20%, 15%, 10%, 5%, 3%, 2%, and 1%; and the amount of polyester in the film may range between any two of these values (e.g., from about 2% to about 15%). The film may be substantially free of polyester.

### First Layer of the Film

The first layer or inside film layer 12 may comprise one or more polymers selected from polyamide and polyester. The first layer may facilitate heat sealing the film to itself or to another object, such as a support member or tray, and accordingly may be considered the sealant layer. Useful films and first layers include those disclosed in U.S. patent application Ser. No. 10/228,515 filed Aug. 27, 2002 entitled “Dual-Ovenable, Heat-Sealable Packaging Film” by Berrier and Ebner, which is incorporated herein in its entirety by reference. Useful support members and trays include those disclosed in U.S. patent application Ser. No. ______ filed Dec. 18, 2002 entitled “Dual-Ovenable, Heat-Sealable Packaging Tray” by Berrier and Ebner (Attorney Docket No. D43471-01), which is incorporated herein in its entirety by reference.

The first layer may comprise one or more polyamides or polyesters or a blend of polyamide and polyester in an amount of any of the following ranges based on the weight of the sealant layer: at least about 70%, at least about 80%, at least about 90%, at least about 95%, at least about 96%, and at least about 98%. Further, the sealant layer may comprise about 100% of polyamide or polyester or a blend of polyamide and polyester, may consist of one or more polyamides or polyesters or a blend of polyamide and polyester, or may consist essentially of one or more polyamides or one or more polyamides or a blend of polyamide

The thickness of first or sealant layer 12 may be selected to provide sufficient material to effect a strong heat seal bond, yet not so thick so as to negatively affect the ovenable characteristics of the film to an unacceptable level. The sealant layer may have a thickness of at least about any of the following values: 0.05 mils, 0.1 mils, 0.15 mils, 0.2 mils, 0.25 mils, 0.3 mils, 0.35 mils, 0.4 mils, 0.45 mils, 0.5 mils, and 0.6 mils. The sealant layer may have a thickness less than about any of the following values: 10 mils, 5 mils, 4 mils, 3 mils, 2 mils, 1 mil, 0.7 mils, 0.5 mils, and 0.3 mils.

The thickness of the first layer as a percentage of the total thickness of the film may be less than about any of the following values: 50%, 40%, 30%, 25%, 20%, 15%, 10%, and 5%; and may range between any of the forgoing values (e.g., from about 10% to about 30%).

Useful polyamides and polyesters may include those that are approved by the controlling regulating agency (e.g., the U.S. Food and Drug Agency) for either direct contact with food and/or for use in a food packaging film, at the desired conditions of use.

To facilitate heat sealing at polyolefin-type sealing conditions (as discussed in the Background section) the sealant layer 12 may have a softening characteristic such that two representative samples of the film that are heat sealed together (with the sealant layers of the films facing each other)—using a ⅛-inch wide sealing bar at a temperature selected from 290° F. and 300° F., a dwell time of 0.5 seconds, and a sealing pressure of 40 psig—forms a heat seal having a seal strength (as discussed below) of at least about any of the following: 1 pound/inch, 2 pound/inch, 2.5 pound/inch, and 3 pounds/inch.

The sealant layer may have a melting point less than about any of the following values: 220° C., 210° C., 200° C., 190° C., and 180° C.; and the melting point of the sealant layer may be at least about any of the following values: 120° C., 130° C., 140° C., and 150° C. All references to the melting point of a polymer, a resin, or a film layer in this application refer to the melting peak temperature of the dominant melting phase of the polymer, resin, or layer as determined by differential scanning calorimetry according to ASTM D-3418.

If the sealant layer comprises amorphous material, then the sealing layer may not clearly display a melting point. The glass transition temperature for the sealing layer may be less than about, and may range between about, any of the following values: 125° C., 120° C., 110° C., 100° C., 90° C., 80° C., 70° C., 60° C., and 50° C.; measured where the relative humidity may be any of the following values: 100%, 75%, 50%, 25%, and 0%. All references to the glass transition temperature of a polymer, a resin, or a film layer in this application refer to the characteristic temperature at which glassy or amorphous polymers become flexible as determined by differential scanning calorimetry (DSC) according to ASTM D-3417.

The first layer (i.e., inside film layer) 12 may comprise less than about any of the following amounts of polyolefin (based on the weight of the first layer): 20%, 15%, 10%, 5%, 3%, 2%, and 1%; and the amount of polyolefin in the first layer may range between any two of these values (e.g., from about 2% to about 15%). The first layer may be substantially free of polyolefin.

The first layer 12 may comprise less than about any of the following amounts of polyester (based on the weight of the first layer): 20%, 15%, 10%, 5%, 3%, 2%, and 1%; and the amount of polyester in the first layer may range between any two of these values (e.g., from about 2% to about 15%). The first layer may be substantially free of polyester.

### Polyamides

Useful polyamides may include those of the type that may be formed by the polycondensation of one or more diamines with one or more diacids and/or of the type that may be formed by the polycondensation of one or more amino acids. Useful polyamides include aliphatic polyamides and aliphatic/aromatic polyamides.

Representative aliphatic diamines for making polyamides include those having the formula:

H₂N(CH₂)ₙNH₂

where n has an integer value of 1 to 16. Representative examples include trimethylenediamine, tetramethylenediamine, pentamethylenediamine, hexamethylenediamine, octamethylenediamine, decamethylenediamine, dodecamethylenediamine, and hexadecamethylenediamine. Representative aromatic diamines include p-phenylenediamine, 4,4′-diaminodiphenyl ether, 4,4′ diaminodiphenyl sulphone, 4,4′-diaminodiphenylethane. Representative alkylated diamines include 2,2-dimethylpentamethylenediamine, 2,2,4-trimethylhexamethylenediamine, and 2,4,4 trimethylpentamethylenediamine. Representative cycloaliphatic diamines include diaminodicyclohexylmethane. Other useful diamines include heptamethylenediamine, nonamethylenediamine, and the like.

Representative diacids for making polyamides include dicarboxylic acids, which may be represented by the general formula:

HOOC—Z—COOH

where Z is representative of a divalent aliphatic radical containing at least 2 carbon atoms. Representative examples include adipic acid, sebacic acid, octadecanedioic acid, pimelic acid, suberic acid, azelaic acid, dodecanedioic acid, and glutaric acid. The dicarboxylic acids may be aliphatic acids, or aromatic acids such as isophthalic acid and terephthalic acid.

The polycondensation reaction product of one or more or the above diamines with one or more of the above diacids may form useful polyamides. Representative polyamides of the type that may be formed by the polycondensation of one or more diamines with one or more diacids include aliphatic polyamides such as poly(hexamethylene adipamide) (“nylon-6,6”), poly(hexamethylene sebacamide) (“nylon-6, 10”), poly(heptamethylene pimelamide) (“nylon-7,7”), poly(octamethylene suberamide) (“nylon-8,8”), poly(hexamethylene azelamide) (“nylon-6,9”), poly(nonamethylene azelamide) (“nylon-9,9”), poly(decamethylene azelamide) (“nylon-10,9”), poly(tetramethylenediamine-co-oxalic acid) (“nylon-4,2”), the polyamide of n-dodecanedioic acid and hexamethylenediamine (“nylon-6, 12”), the polyamide of dodecamethylenediamine and n-dodecanedioic acid (“nylon-12,12”).

Representative aliphatic/aromatic polyamides include poly(tetramethylenediamine-co-isophthalic acid) (“nylon-4,I”), polyhexamethylene isophthalamide (“nylon-6,I”), poly (2,2,2-trimethyl hexamethylene terephthalamide), poly(m-xylylene adipamide) (“nylon-MXD,6”), poly(p-xylylene adipamide), poly(hexamethylene terephthalamide), poly(dodecamethylene terephthalamide), and polyamide-MXD,I.

Representative polyamides of the type that may be formed by the polycondensation of one or more amino acids include poly(4-aminobutyric acid) (“nylon-4”), poly(6-aminohexanoic acid) (“nylon-6” or “poly(caprolactam)”), poly(7-aminoheptanoic acid) (“nylon-7”), poly(8-aminooctanoic acid) (“nylon-8”), poly(9-aminononanoic acid) (“nylon-9”), poly(10-aminodecanoic acid) (“nylon-10”), poly(11-aminoundecanoic acid) (“nylon-11”), and poly(12-aminododecanoic acid) (“nylon-12”).

Representative copolyamides include copolymers based on a combination of the monomers used to make any of the foregoing polyamides, such as, nylon-4/6, nylon-6/6, nylon-6/9, caprolactam/hexamethylene adipamide copolymer (“nylon-6,6/6”), hexamethylene adipamide/caprolactam copolymer (“nylon-6/6,6”), trimethylene adipamide/hexamethylene azelaiamide copolymer (“nylon-trimethyl 6,2/6,2”), hexamethylene adipamide-hexamethylene-azelaiamide caprolactam copolymer (“nylon-6,6/6,9/6”), hexamethylene adipamide/hexamethylene-isophthalamide (“nylon-6,6/6,I”), hexamethylene adipamide/hexamethyleneterephthalamide (“nylon-6,6/6,T”), nylon-6,T/6,I, nylon-6/MXD,T/MXD,I, nylon-6,6/6,10, and nylon-6,i/6,T.

Conventional nomenclature typically lists the major constituent of a copolymer before the slash (“/”) in the name of a copolymer; however, in this application the constituent listed before the slash is not necessarily the major constituent unless specifically identified as such. For example, unless the application specifically notes to the contrary, “nylon-6/6,6” and “nylon-6,6/6” may be considered as referring to the same type of copolyamide.

Polyamide copolymers may include the most prevalent polymer unit in the copolymer (e.g., hexamethylene adipamide as a polymer unit in the copolymer nylon-6,6/6) in mole percentages ranging from any of the following: at least about 50%, at least about 60%, at least about 70%, at least about 80%, and at least about 90%, and the ranges between any of the forgoing values (e.g., from about 60 to about 80%); and may include the second most prevalent polymer unit in the copolymer (e.g., caprolactam as a polymer unit in the copolymer nylon-6,6/6) in mole percentages ranging from any of the following: less than about 50%, less than about 40%, less than about 30%, less than about 20%, less than about 10%, and the ranges between any of the forgoing values (e.g., from about 20 to about 40%).

The sealant layer may comprise more than one polyamide such as a blend of polyamides, for example, two polyamides, at least two polyamides, three polyamides, and at least three polyamides. The sealant layer may comprise a first polyamide in any of the following amounts (based on the weight of the sealant layer): at least about 40%, at least about 50%, at least about 60%, at least about 70%, at least about 80%, at least about 90%, at least about 95%, and the ranges between any of these forgoing values (e.g., from about 60 to about 80%).

The sealant layer may comprise a second polyamide in any of the following amounts (based on the weight of the sealant layer): less than about 60%, less than about 50%, less than about 40%, less than about 30%, less than about 20%, less than about 10%, and less than about 5%, and the ranges between any of these forgoing values (e.g., from about 20 to about 40%).

The sealant layer may comprise a third polyamide in any of the following amounts (based on the weight of the sealant layer): less than about 60%, less than about 50%, less than about 40%, less than about 30%, less than about 20%, less than about 10%, and less than about 5%, and the ranges between any of these forgoing values (e.g., from about 20 to about 40%).

Each of the first, second, and third polyamides of the sealant layer may be selected from any of the polyamides described above, for example, nylon-6, nylon-6,6, nylon-6,12, nylon-6,6/6,10, and nylon-6,I/6,T. The sealant layer may comprise at least one of nylon-6 and nylon-6,6. The sealant layer may comprise, for example, any of the following combinations: nylon-6 and nylon-6,6/6,10; nylon-6 and nylon-6,I/6,T; nylon-6,6 and nylon-6,12; nylon-6, nylon-6,6/6,10, and nylon-6,I/6,T; and nylon-6, nylon-6,12, and nylon-6,I/6,T.

The sealant layer may comprise a polyamide blend comprising one or more relatively high-melting point polyamides with one or more relatively low-melting point polyamides. The sealant layer may comprise such a polyamide blend in at least about any of the following amounts based on the weight of the sealant layer: 70%, 80%, 90%, and 95%. The relatively high-melting point polyamides may have a melting point of at least about any of the following values: 210° C., 215° C., 220° C., 225° C., 230° C., 235° C., 240° C., 245° C., 250° C., 255° C., 260° C., 265° C., 270° C., 275° C., 280° C., 285° C., 290° C., 295° C., and 300° C.; and may range between any of the forgoing values (e.g., from about 235 to about 280° C.). Representative relatively high-melting point polyamides may include nylon-6, nylon-6,6, nylon-6/6,6, nylon-6,10, nylon-6,12, nylon-6/6,T, nylon-MXD,6, nylon-4,6, nylon-6,9, and nylon-6,6/6,10 (having less than about 10% or more than about 60% nylon-6,6 in the copolymer).

The relatively low-melting point polyamides may have a melting point of less than about any of the following values: 210° C., 205° C., 200° C., 195° C., 190° C., 185° C., and 180° C. Representative relatively low-melting point polyamides may include nylon-6/12, nylon-12, nylon-12,T, nylon-6/6,9, nylon-11, and nylon-6,6/6,10 (having from about 10% to about 60% nylon-6,6 in the copolymer).

The amount of relatively high-melting point polyamide in the polyamide blend of relatively high-melting point polyamide with relatively low-melting point polyamide may be at least about, may be less than about, and may range between about any of the following amounts (based on the weight of the blend): 1%, 5%, 10%, 20%, 30%, 40%, and 50%. The amount of relatively low-melting point polyamide in the blend of relatively high-melting point polyamide with relatively low-melting point polyamide may be at least about, may be less than about, and may range between about any of the following amounts (based on the weight of the blend): 50%, 60%, 70%, 80%, 90%, 95%, and 99%.

The sealant layer may comprise a polyamide blend comprising a first relatively high-melting point polyamide with a second relatively high-melting point polyamide. The sealant layer may comprise such a polyamide blend in at least about any of the following amounts based on the weight of the sealant layer: 70%, 80%, and 90%.

The sealant layer may comprise a blend of two or more polyamides where each polyamide of the blend has a melting point higher than the melting point of the blend, for example, where the melting point range for the blend includes any of the melting point ranges as set forth for the sealant layer above.

The sealant layer may comprise one or more amorphous polyamides, for example, nylon-6,I/6,T. The sealant layer may comprise amorphous polyamide in an amount at least about, at most about, and ranging between about any of the following values (based on the weight of the sealant layer): 20%, 30%, 40%, 50%, 60%, 70%, and 80%.

### Polyesters

Useful polyesters include homopolymers or copolymer polyesters. The polyester may have a terephthalic acid mer content of at least about any of the following: 70 mole %, 80 mole %, 85 mole %, 90 mole %, and 95 mole %. Examples of suitable polyesters include polyethylene terephthalate (“PET”) homopolymer, PET copolymers, poly(ethylene 1,4-cyclohexenedimethylene) terephthalate, polyethylene isophthalate, polyethylene naphthalate (“PEN”) homopolymer, and PEN copolymers. Useful polyesters include amorphous polyester or crystalline polyester (e.g., CPET).

### Second Layer of the Film

The second layer 14 may comprise one or more polyamides or polyesters or a blend of polyamide and polyester, such as any of the polyamides and polyesters discussed above in any of the following amounts based on the weight of the second layer: at least about 70%, at least about 80%, at least about 90%, at least about 95%, at least about 96%, and at least about 98%. Further, the second layer may comprise about 100%, may consist of, or may consist essentially of one or more polyamides or one or more polyesters or a blend of polyamide and polyester.

The second layer may comprise more than one polyamide such as a blend of polyamides, for example, two polyamides, at least two polyamides, three polyamides, and at least three polyamides. The second layer may comprise a first polyamide of at least about, and between about, any of the following amounts (based on the weight of the second layer): 60%, 70%, 80%, and 90%. The second layer may comprise a second polyamide of less than about, and between about, any of the following amounts (based on the weight of the second layer): 50%, 40%, 30%, 20%, and 10%.

Each of the first and second polyamides of the second layer may be selected from, for example, nylon-6, nylon-6,6, nylon-6/6,6, nylon-6,10, nylon-6,12, nylon-6,6/6,10, nylon-6/6,T, nylon-MXD,6, and nylon-4,6. The second layer may comprise any of nylon-6, nylon-6,6, and nylon-6/6,6, and combinations thereof, such as both nylon-6 and nylon-6,6.

The second layer may comprise one or more amorphous polyamides, for example, nylon-6,I/6,T. The second layer may comprise amorphous polyamide in an amount at least about, at most about, and ranging between about any of the following values (based on the weight of the second layer): 10%, 20%, 30%, 40%, 50%, 60%, 70%, and 80%.

To enhance the high-temperature performance of the film, the second layer 14 may have a melting point of at least about any of the following values: 210° C., 220° C., 230° C., 240° C., 250° C., 260° C., 270° C., 280° C., 290° C., and 300° C.; and may range between any of these forgoing values.

The glass transition temperature for the second layer may be less than about, and may range between, any of the following values: 125° C., 120° C., 110° C., 100° C., 90° C., 80° C., 70° C., 60° C., and 50° C.; measured where the relative humidity may be any of the following values: 100%, 75%, 50%, 25%, and 0%.

The second layer may have a melting point greater than the melting point of the sealant layer by at least about any of the following values: 20° C., 30° C., 40° C., 50° C., 60° C., 70° C., 80° C., 90° C., and 100° C.

The second layer may comprise a polyamide blend comprising two or more relatively high-melting point polyamides, such as those discussed above with respect to the sealant layer.

The amount of relatively high-melting point polyamide in the polyamide blend of the second layer may be at least about, and may range between, any of the following amounts (based on the weight of the blend): 70%, 80%, 90%, 95%, 100%.

The thickness of second layer 14 may be selected to provide sufficient material to enhance the ovenable characteristics of the film. The second layer may have a thickness of at least about any of the following values: 0.5 mils, 0.75 mils, 1 mil, 2 mils, 3 mils, 4 mils. The second layer may have a thickness less than about any of the following values: 10 mils, 6 mils, 5 mils, 4 mils, and 3 mils. The thickness of the second layer as a percentage of the total thickness of the film may be at least about any of the following values: 40%, 50%, 60%, 70%, 80%, and 90%; and may range between any of the forgoing values (e.g., from about 40% to about 90%).

### Other Layers of the Film

The film may include one or more additional layers 22, 24. The additional layers may comprise any of the materials, and in any of the amounts, discussed above with respect to the first and second layers.

The additional layers 22, 24 may comprise one or more barrier components. Useful barrier components include: ethylene/vinyl alcohol copolymer (“EVOH”), polyacrylonitrile (“PAN”), and polyamide, for example, nylon-MXD,6 (either with or without nanocompo site), nylon-MXD,6/MXD,I.

EVOH may have an ethylene content of, for example, between about 20% and 45%, between about 25% and 35%, and 32% by weight. EVOH may include saponified or hydrolyzed ethylene/vinyl acetate copolymers, such as those having a degree of hydrolysis of at least 50%, preferably of at least 85%. EVOH may be a retortable grade EVOH, such as those available from Nippon Goshei.

The additional layer comprising a barrier component may have a thickness and composition sufficient to impart to the film incorporating the barrier layer an oxygen transmission rate of no more than about any of the following values: 150, 100, 50, 45, 40, 35, 30, 25, 20, 15, 10, and 5 cubic centimeters (at standard temperature and pressure) per square meter per day per 1 atmosphere of oxygen pressure differential measured at 0% relative humidity and 23° C. All references to oxygen transmission rate in this application are measured at these conditions according to ASTM D-3985.

An additional layer may comprise barrier component in an amount of at least about any of the following: 50%, 60%, 70%, 80%, 90%, and 100%, based on the weight of the additional layer comprising the barrier component. The thickness of an additional layer may be any of the following: from about 0.05 to about 6 mils, from about 0.05 to about 4 mils, from about 0.1 to about 3 mils, and from about 0.12 to 2 mils.

### Additives

Either or both of the layers 12 and 14—or any of the polyamide or polyester resins or blends—may comprise effective amounts of one or more nucleating agents. Effective amounts and types of nucleating agents are known to those of skill in the art.

Either or both of the layers 12 and 14—or any of the polyamide or polyester resins or blends—may comprise effective amounts of one or more nanocomposite clay materials. Effective amounts and types of nanocomposite agents are known to those of skill in the art.

Either or both of the layers 12 and 14—or any of the polyamide or polyester resins or blends—may comprise effective amounts of one or more heat stabilizers. Effective amounts and types of heat stabilizers are known to those of skill in the art, and include, for example, those available under the the Solutia NA-189 trademark and the Honeywell MB-HS trademark. The layer may comprise at least about any of the following amounts of heat stabilizer: 0.2%, 0.5%, 0.8%, 1%, 1.3%, 1.5%, 2%, 2.5%, 3%, 4%, and 5%, and may range between any of those values (e.g., from about 0.5% to about 3%).

One of more of the layers 12, 14, 22, 24 may include one or more additives useful in packaging films, such as, antiblocking agents, slip agents, antifog agents, colorants, pigments, dyes, flavorants, antimicrobial agents, meat preservatives, antioxidants, fillers, radiation stabilizers, and antistatic agents. Such additives, and their effective amounts, are known in the art.

### Film Characteristics

The film 10, 20, 30, 40 may be capable of forming heat seals under “polyolefin-type” heat seal conditions where the heat seals have a seal strength that can withstand the expected conditions of use in microwave and conventional ovens. To determine whether a film has such a capability, for example, a water-containing package is formed by providing two 4 inch by 6 inch sheets of the film. The sheets are placed in superimposed, coextensive arrangement having the first layers of the films in contact with each other. Three perimeter sides of the sheets are heat sealed together using a ⅛-inch wide sealing bar at a specified temperature selected from 290° F. and 300° F., a dwell time of 0.5 seconds, and a sealing pressure of 40 psig to form an open pouch having heat seals along three of the four perimeter sides. The pouch is filled with 100 milliliters of distilled water at a temperature of 73° F. The fourth perimeter sides of the sheets are heat sealed together under the same conditions as used to seal the three perimeter sides. The resulting closed pouch has a heat seal along the fourth perimeter side and contains the water.

The closed, water-containing pouch is exposed to an amount of time selected from three or four hours in a conventional oven at 400° F. (air temperature). After removal from the oven and cooling to room temperature, representative samples are cut from the pouch to measure the seal strength of the heat seals. The resulting seal strength of the heat seals may be at least about any of the following values: 1, 1.5, 2, 2.5, 3, 3.5, 4, 4.5, 5, 6, and 10 pounds/inch. The term “seal strength of a heat seal” (or similar terms) as used herein means the maximum amount of force (pounds/inch) required to separate or delaminate two films that have been heat sealed together, as measured in accordance with ASTM F88-94 where the Instron tensile tester crosshead speed is 5 inches per second, using five, 1-inch wide, representative samples.

Haze is a measurement of the transmitted light scattered more than 2.5° from the axis of the incident light. Haze is measured against the outside surface 16 or 18 of the film (FIGS. 1 to 4), according to the method of ASTM D 1003, which is incorporated herein in its entirety by reference. All references to “haze” values in this application are by this standard. The haze of the film may be no more than about any of the following values: 20%, 15%, 10%, 9%, 8%, 7%, 6%, 5%, 4%, 3%, and 1%. The film may have any of these haze values after a representative sample of the film is placed for two hours in a conventional oven having an air temperature of 400° F.

The film may be transparent (at least in the non-printed regions) so that the packaged article is visible through the film. “Transparent” as used herein means that the material transmits incident light with negligible scattering and little absorption, enabling objects (e.g., packaged food or print) to be seen clearly through the material under typical unaided viewing conditions (i.e., the expected use conditions of the material). The transparency (i.e., clarity) of the film may be at least about any of the following values: 20%, 25%, 30%, 40%, 50%, 65%, 70%, 75%, 80%, 85%, and 95%, as measured in accordance with ASTM D1746. All references to “transparency” values in this application are by this standard.

The transparency and the haze of the film may be measured before and after the film has been formed into a closed, water-containing pouch, as discussed above, and after the package has been exposed in a conventional oven at 400° F. (air temperature) for an amount of time selected from 3 hours and 4 hours. After removal from the oven and cooling to room temperature, representative samples may be taken from the pouch. The transparency and haze of the film before and after this exposure may remain substantially the same—for example, the transparency may not have decreased by more than 5% points (e.g., from a 95% transparency to a 90% transparency) and the haze may not have increased by more than 5% points (e.g., from 10% haze to 15% haze).

The film may have a heat-shrinkable attribute. For example, the film may have a free shrink in at least one direction (i.e., machine or transverse direction), in at least each of two directions (machine and transverse directions), or a total free shrink measured at 220° F. of at least about any of the following: 3%, 7%, 10%, 15%, 20%, 25%, 30%, 40%, 50%, 55%, 60%, and 65%. Further, the film may have any of a free shrink in at least one direction (machine or transverse direction), in at least each of two directions (machine and transverse directions), or a total free shrink of at least about any of these listed shrink values when measured at any of 100° F., 120° F., 140° F., 160° F., 185° F., 190° F., 200° F., and 210° F.

As is known in the art, the total free shrink is determined by summing the percent free shrink in the machine (longitudinal) direction with the percentage of free shrink in the transverse direction. For example, a film which exhibits 50% free shrink in the transverse direction and 40% free shrink in the machine direction has a total free shrink of 90%. Although preferred, it is not required that the film have shrinkage in both directions. Unless otherwise indicated, each reference to free shrink in this application means a free shrink determined by measuring the percent dimensional change in a 10 cm×10 cm specimen when subjected to selected heat (i.e., at a certain temperature exposure) according to ASTM D 2732.

The film may have a thickness and composition sufficient to impart to the film an oxygen transmission rate of no more than about any of the following values: 150, 100, 50, 45, 40, 35, 30, 25, 20, 15, 10, and 5 cubic centimeters (at standard temperature and pressure) per square meter per day per 1 atmosphere of oxygen pressure differential measured at 0% relative humidity and 23° C.

The film may have a thickness of at least about any of the following values: 0.5 mils, 1 mils, 1.5 mils, 2 mils, 2.5 mils, 3 mils, 3.5 mils, 4 mils, 4.5 mils, 5 mils, and 6 mils. The film may have a thickness less than about any of the following values: 60 mils, 50 mils, 40 mils, 35 mils, 30 mils, 25 mils, 20 mils, 15 mils, 10 mils, 5 mils, 4 mils, 3 mils, 2 mils, and 1 mil. Further, the film thickness may range between about any of the forgoing values (e.g., between about 4 mils to about 20 mils).

### Manufacture of the Film

The film of the present invention may be manufactured by thermoplastic film-forming processes known in the art (e.g., tubular or blown-film extrusion, coextrusion, extrusion coating, flat or cast film extrusion). A combination of these processes may also be employed.

The film may be oriented or non-oriented. The film may be oriented in either the machine (i.e., longitudinal) or the transverse direction, or in both directions (i.e., biaxially oriented), for example, in order to enhance the optics, strength, and durability of the film. For example, the film may be oriented in one of the machine or transverse directions or in both of these directions by at least about any of the following ratios: 2:1, 2.5:1, 2.7:1, 3:1, 3.5: 1, and 4:1. The film may be oriented in one of the machine or transverse directions or in both of these directions by no more than about any of the following ratios: 10:1, 9:1, 8:1, 7:1, 6:1, 5:1, and 4:1. If the film is oriented, then it may be heat set or annealed after orientation to reduce the heat shrink attribute to a desired level or to help obtain a desired crystalline state of the film.

### Package

The unperforated package useful in the method of the present invention may comprise the film (e.g., film 10, 20, 30, or 40). For example, the package may comprise a bag comprising the film, a thermoformed or unformed base web comprising the film, and/or a lid comprising the film. Further, the unperforated package may consist essentially of the film, for example, so that the internal film layer of the film is essentially the only packaging structure directly adjacent the internal space of the unperforated package.

The film may be heat sealed to itself, another film (not shown), or a support member (not shown), such as a thermoformed tray. The film may be made into, for example, a bag or pouch suitable for packaging a food product, using for example, a fin seal and/or a lap seal arrangement. In forming such a package, the first layer or inside film layer 12 of the film may be sealed to itself to form the heat seal seams 52 of the bag. In this manner, the first layer 12 (i.e., the “heat seal layer” or “sealant layer”) of the film is considered the “inside” or food-side layer of the film and the package made from the film. Thus, the inside film layer 12 may be adjacent the internal space inside the package. The “outside layer” of the film may be second layer 14 (as shown in FIG. 1) or the outside layer may formed by one of the one or more layers 24 (as shown in FIG. 4). The bag or pouch may be closed to form the unperforated package by one or more heat seals 52 (FIG. 5) or may be closed using a metal or plastic clip or tie (not shown) as is known in the art. However, the unperforated package may free of a clip or a tie closure device, for example, free of a metal clip or a metal tie closure device.

One or more meat products (discussed below) may be packaged within the internal space defined by the package. In packaging the meat, a vacuum may be drawn on the internal space of the package so that the pressure of the internal space of the resulting unperforated package may be less than about any of the following values (psia): 13.7; 13, 12, 11, 10, 9, 8, 7, 6, 5, 4, 3, 2, 1, 0.5, and 0.25 psia.

The unperforated package enclosing the meat within the internal space of the package may be formed by one or more of the vacuum packaging methods known to those of skill in the art, for example, the shrink bag method of vacuum packaging, the non-shrink bag method of vacuum packaging, the thermoforming method of vacuum packaging, and the vacuum skin packaging method of vacuum packaging. See, for example, Robertson, Food Packaging Principals and Practice, p.445-449 (1993), of which the entire book is incorporated herein by reference.

An “unperforated” package as used herein means that the package does not have a perforation, a hole, and/or an opening (such as a failed heat seal region or failed closure mechanism) that allows the pressure of the internal space of the package to equilibrate with the ambient pressure outside of the package.

The package may comprise one or more polyamides, one or more polyesters, or a blend of polyamide and polyester in an amount of any of the following ranges based on the weight of the package (without the packaged product): at least about 70%, at least about 80%, at least about 90%, at least about 95%, at least about 96%, and at least about 98%. Further, the package may comprise about 100%, may consist of, or may consist essentially of one or more polyamides, one or more polyesters, or a blend of polyamide and polyester.

The package may comprise less than about any of the following amounts of polyolefin (based on the weight of the package without the packaged product): 20%, 15%, 10%, 5%, 3%, 2%, and 1%; and the amount of polyolefin in the film may range between any two of these values (e.g., from about 2% to about 15%). The package may be substantially free of polyolefin.

The package may comprise less than about any of the following amounts of polyester (based on the weight of the package without the packaged product): 20%, 15%, 10%, 5%, 3%, 2%, and 1%; and the amount of polyester in the film may range between any two of these values (e.g., from about 2% to about 15%). The package may be substantially free of polyester.

### Heating the Packaged Meat

The meat may be enclosed in the internal space inside the package after the meat is cooked, or the meat may be cooked after the meat is enclosed within the internal space inside the package. The term “cooked meat” may be used to describe a meat that has been subjected to heat to induce reaction of meat components (e.g., those derived from proteins, carbohydrates, nucleotides, and lipids) to enhance the flavor relative to the raw meat.

Meat that may be used in the method of the present invention includes, for example, red meat products (e.g., beef, veal, lamb, and pork), poultry (e.g., chicken and turkey), fish, hamburger, and sausage.

After the cooked meat is enclosed in the unperforated package, the cooked meat may be stored in the unperforated packaging in the unperforated state for any of the following periods: at least 1 day, at least 2 days, at least 3 days, at least 4 days, at least 5 days, at least 6 days, at least 1 week, and at least 2 weeks. Further, the cooked meat may be stored in the unperforated packaging for a time period ranging between any of the forgoing values (e.g., from 2 days to 1 week).

The cooked meat enclosed in the unperforated packaging may be stored (e.g., refrigerated) for any of the above time periods while the internal temperature of the meat is less than about any of the following values: 45° F., 40° F., 33° F., 32° F., and 25° F.

The unperforated package enclosing the cooked food in the internal space of the package may be provided where the internal temperature of the cooked meat is less than about any of the following values: 100° F., 80° F., 60° F., 45° F., 40° F., 33° F., 32° F., and 25° F. Further, the unperforated package enclosing the cooked food in the internal space of the package may be provided where the internal space has a pressure of less than about any of the following values: 13.7; 13, 12, 11, 10, 9, 8, 7, 6, 5, 4, 3, 2, 1, 0.5, and 0.25 psia.

Subsequent to this providing step, the cooked meat may be heated to a desired internal meat temperature while the cooked meat is within the internal space and the package remains in the unperforated state. The cooked meat may be heated to an internal meat temperature of at least about any of the following values: 100° F., 110° F., 120° F., 130° F., 140° F., 150° F., 160° F., 170° F., and 180° F. This heating step may be accomplished by heating the cooked meat in an oven having an air temperature of at least about any of the following values: 250° F., 275° F., 300° F., 325° F., 350° F., 375° F., and 400° F. Alternatively, the heating step may be accomplished by heating the cooked meat in a microwave oven. Also, the heating step may be accomplished by placing the unperforated package in a heated liquid, for example, water at or near its boiling temperature.

The following examples are presented for the purpose of further illustrating and explaining the present invention and are not to be taken as limiting in any regard. Unless otherwise indicated, all parts and percentages are by weight.

In the following examples these abbreviations may be used:

“PA1-6” is a nylon-6 having a melting point of 220° C. available from BASF Corporation (Parsippany, N.J.) under the Ultramid B4 trademark.

“PA2-6 and -6,6” is a blend of nylon-6 and nylon-6,6 believed to include about 50 to 55 weight % nylon-6 and about 45 to 50 weight % nylon-6,6 available from Honeywell Corporation under the Capron 2120 FN trademark.

“PA3-6” is a nylon-6 having a melting point of 220° C. available from Honeywell Corporation under the Capron B205 trademark.

“PA1-6N” is a nylon-6 with 1% nucleating agent having a melting point of 220° C. available from BASF Corporation (Parsippany, N.J.) under the Ultramid KR4418 trademark.

“PA1-6,6” is a nylon-6,6 having a melting point of 264° C. available from Solutia Corporation (Pensacola, Fla.) and supplied by Prime Alliance (Des Moines, Iowa) under the ASCEND 66J trademark.

“PA2-6,6” is a nylon-6,6 having a melting point of 264° C. available from BASF Corporation under the Ultramid A4 trademark.

“PA1-6/12” is a nylon-6/12 having a melting point of 130° C. available from EMS Corporation (Sumter, S.C.) under the Grilon CF6S trademark.

“PA1-6,6/6” is a nylon-6,6/6 copolymer having a melting point of 217° C. available from Solutia Corporation (Pensacola, Fla.) and supplied by Prime Alliance (Des Moines, Iowa) under the Ascend 76HF trademark.

“PA1-6,6/6, 10” is a nylon-6,6/6,10 having a melting point of 200° C. available from EMS Corporation (Sumter, S.C.) under the Grilon BM20SBG trademark.

“PA1-6,I/6,T” is an amorphous nylon-6,I/6,T copolymer having a dry glass transition temperature of 125° C. available from Dupont Corporation (Wilmington, Del.) under the Selar 2072 trademark.

“PA1-MXD,6” is a nylon-MXD,6 having a melting point of 243° C. available from Mitsubishi Corporation under the Nylon MXD6-6007 tradename.

“PA2-MXD,6” is a nylon-MXD,6 including nanocomposite available from Nanocor Corporation (Arlington Heights, Ill.) under the Imperm N37 tradename.

“HS” is a heat stabilizer masterbatch available from Solutia Corporation (Pensacola, Fla.) and supplied by Prime Alliance (Des Moines, Iowa) under the NA-189 trade name.

“EVOH” is a retortable grade ethylene/vinyl alcohol having a melting point of 183° C. and an ethylene content of 32 mole % available from Nippon Goshei (via Soarus of Arlington Heights, Ill.) under the tradename Soamol SG372B.

### EXAMPLES 1-10

The examples 1-10 shown in Table 1 below were made by a cast film extrusion process.

TABLE 1

| | | Thickness | | PA2-6 | PA1- | PA1- | PA1- | PA1- | PA1- | |
|---|---|---|---|---|---|---|---|---|---|---|
| | Layer | (mil) | PA1-6 | and -6,6 | 6,6 | 6/12 | 6,6/6,10 | 6,6/6 | 6,I/6,T | EVOH |
| Ex 1 | 1st | 0.25 | | | 80% | 20% | | | | |
| | 2^{nd} | 0.875 | | 100% | | | | | | |
| | 3rd | 0.875 | | 100% | | | | | | |
| Ex 2 | 1st | 0.25 | | | 40% | 60% | | | | |
| | 2^{nd} | 0.875 | | 100% | | | | | | |
| | 3rd | 0.875 | | 100% | | | | | | |
| Ex 3 | 1st | 0.25 | | | 20% | 80% | | | | |
| | 2^{nd} | 0.875 | | 100% | | | | | | |
| | 3rd | 0.875 | | 100% | | | | | | |
| Ex 4 | 1st | 0.25 | 25% | | | | 75% | | | |
| | 2^{nd} | 1.75 | | | | | | 100% | | |
| Ex 5 | 1st | 0.25 | 30% | | | | | | 70% | |
| | 2^{nd} | 1.75 | | | | | | 100% | | |
| Ex 6 | 1st | 0.25 | 25% | | | | 75% | | | |
| | 2^{nd} | 1.75 | 40% | | 60% | | | | | |
| Ex 7 | 1st | 0.25 | 30% | | | | | | 70% | |
| | 2^{nd} | 1.75 | 40% | | 60% | | | | | |
| Ex 8 | 1st | 0.25 | 25% | | | | 75% | | | |
| | 2^{nd} | 0.875 | | | | | | 100% | | |
| | 3^{rd} | 0.875 | 40% | | 60% | | | | | |
| Ex 9 | 1st | 0.25 | 25% | | | | 75% | | | |
| | 2^{nd} | 0.875 | | | | | | | | 100% |
| | 3rd | 0.875 | 40% | | 60% | | | | | |
| Ex 10 | 1st | 0.25 | 25% | | | | 75% | | | |
| | 2^{nd} | 0.875 | | | | | | | | 100% |
| | 3rd | 0.875 | | | | | | 100% | | |

### EXAMPLES 11-24

The Examples 11-24 shown in Table 2 below were made by a blown film extrusion process.

TABLE 2

| | | | | | PA1- | PA1- | PA2- | PA1- | PA1- | PA1- | PA2- | | |
|---|---|---|---|---|---|---|---|---|---|---|---|---|---|
| | | Thickness | PA1-6 | PA3-6 | 6N | 6,6 | 6,6 | 6,6/6,10 | 6,I/6,T | MXD, 6 | MXD, 6 | HS | EVOH |
| | Layer | (mil) | (wt %) | (%) | (%) | (%) | (%) | (%) | (%) | (%) | (%) | (%) | (%) |
| Ex | 1^{st} | 0.25 | 24 | | | | | 75 | | | | 1 | |
| 11 | | | | | | | | | | | | | |
| | 2^{nd} | 1.5 | 40 | | | 60 | | | | | | | |
| | 3^{rd} | 0.25 | 24 | | | | | 75 | | | | 1 | |
| Ex | 1^{st} | 0.25 | 30 | | | | | | 69 | | | 1 | |
| 12 | | | | | | | | | | | | | |
| | 2^{nd} | 0.875 | 40 | | | 60 | | | | | | | |
| | 3^{rd} | 0.875 | 30 | | | | | | 69 | | | 1 | |
| Ex | 1^{st} | 0.56 | 20 | | | | | 59 | 20 | | | 1 | |
| 13 | | | | | | | | | | | | | |
| | 2^{nd} | 1.41 | 70 | | | 30 | | | | | | | |
| Ex | 1^{st} | 0.56 | | | 20 | | | 59 | 20 | | | 1 | |
| 14 | | | | | | | | | | | | | |
| | 2^{nd} | 1.41 | | | 40 | 60 | | | | | | | |
| Ex | 1^{st} | 0.47 | 20 | | | | | 59 | 20 | | | 1 | |
| 15 | | | | | | | | | | | | | |
| | 2^{nd} | 1.43 | | 40 | | 60 | | | | | | | |
| Ex | 1^{st} | 0.62 | 20 | | | | | 59 | 20 | | | 1 | |
| 16 | | | | | | | | | | | | | |
| | 2^{nd} | 0.45 | 69.3 | | | 30 | | | | | | 0.7 | |
| | 3^{rd} | 0.29 | | | | | | | | | | | 100 |
| | 4^{th} | 0.72 | 69.3 | | | 30 | | | | | | 0.7 | |
| Ex | 1^{st} | 0.50 | 20 | | | | | 59 | 20 | | | 1 | |
| 17 | | | | | | | | | | | | | |
| | 2^{nd} | 1.40 | 40 | | | | 60 | | | | | | |
| Ex | 1^{st} | 0.40 | 20 | | | | | 59 | 20 | | | 1 | |
| 18 | | | | | | | | | | | | | |
| | 2^{nd} | 0.50 | 39.6 | | | 60 | | | | | | 0.4 | |
| | 3^{rd} | 0.35 | | | | | | | 100 | | | | |
| | 4^{th} | 0.50 | 39.6 | | | 60 | | | | | | 0.4 | |
| Ex | 1^{st} | 0.50 | 20 | | | | | 59 | 20 | | | 1 | |
| 19 | | | | | | | | | | | | | |
| | 2^{nd} | 0.50 | 39.6 | | | 60 | | | | | | 0.4 | |
| | 3^{rd} | 0.25 | | | | | | | | | | | 100 |
| | 4^{th} | 0.50 | 39.6 | | | 60 | | | | | | 0.4 | |
| Ex | 1^{st} | 0.50 | 20 | | | | | 59 | 20 | | | 1 | |
| 20 | | | | | | | | | | | | | |
| | 2^{nd} | 0.50 | 39.6 | | | 60 | | | | | | 0.4 | |
| | 3^{rd} | 0.50 | | | | | | | | 100 | | | |
| | 4^{th} | 0.50 | 39.6 | | | 60 | | | | | | 0.4 | |
| Ex | 1^{st} | 0.5 | 20 | | | | | 59 | 20 | | | 1 | |
| 21 | | | | | | | | | | | | | |
| | 2^{nd} | 1.5 | 39 | | | 60 | | | | | | 1 | |
| Ex | 1^{st} | 0.58 | 20 | | | | | 59 | 20 | | | 1 | |
| 22 | | | | | | | | | | | | | |
| | 2^{nd} | 0.53 | 39.6 | | | 60 | | | | | | 0.4 | |
| | 3^{rd} | 0.27 | | | | | | | | | 100 | | |
| | 4^{th} | 0.98 | 39.6 | | | 60 | | | | | | 0.4 | |
| Ex | 1^{st} | 0.5 | 24 | | | | | 75 | | | | 1 | |
| 23 | | | | | | | | | | | | | |
| | 2^{nd} | 1.5 | 40 | | | 60 | | | | | | | |
| Ex | 1^{st} | 0.5 | 20 | | | | | 59 | 20 | | | 1 | |
| 24 | | | | | | | | | | | | | |
| | 2^{nd} | 1.5 | 69.3 | | | 30 | | | | | | 0.7 | |

The Example 16 film had a haze of 11.6%, a transmittance of 93.6%, and a clarity of 29.08%. The Example 23 film had a haze of 26.03%, a transmittance of 93.8%, and a clarity of 1.00%. The Example 24 film had a haze of 13.65%, a transmittance of 93.6%, and a clarity of 33.43%. Transmittance is measured according to the method of ASTM D 1003. All references to “transmittance” values in this application are by this standard.

A heal was formed (or was attempted to be formed) for each of the following films shown in Table 3 by placing the heat seal layer of a sheet of the subject film in contact with the heat seal layer of another sheet of the same film. The superimposed sheets were exposed to 80 psig sealing pressure for a 1 second dwell time using a Sencorp Model 12ALS/1 sealer at the seal bar shown below. The strength of the resulting heat seal is shown in Table 3.

TABLE 3

| Seal Bar Temp | Example 21 | Example 19 |
|---|---|---|
| (° F.) | Seal Strength (lbf/in) | Seal Strength (lbf/in) |
| 266 | 0.298 | 0.367 |
| 284 | 2.52 | 7.49 |
| 302 | 6.83 | 9.4 |
| 320 | 6.2 | 8.47 |

A heat seal was formed (or was attempted to be formed) for each of the following films shown in Table 4 by placing the heat seal layer of a sheet of the subject film in contact with the heat seal layer of another sheet of the same film. The superimposed sheets were exposed to 40 psig sealing pressure for a 0.5 second dwell time using a Sencorp Model 12ALS/1 sealer at the seal bar temperature shown below. The strength of the resulting heat seal is shown in Table 4. Sample 1 is a 1.2 mil mono-layer nylon film commercially available from Gem Polymer Corporation as Crystal 33. Sample 2 is a 0.79 mil mono-layer film of nylon-6 and nylon-6,6 blend commercially available from Reynolds Corporation under the Reynolds Oven Bag trade name.

TABLE 4

| | Example | Example | Example | | |
|---|---|---|---|---|---|
| | 21 | 19 | 13 | Sample 1 | Sample 2 |
| | Seal | Seal | Seal | Seal | Seal |
| Seal Bar | Strength | Strength | Strength | Strength | Strength |
| Temp (° F.) | (lbf/in) | (lbf/in) | (lbf/in) | (lbf/in) | (lbf/in) |
| 257 | 0.135 | 0.128 | 0.152 | | |
| 266 | 0.227 | 0.207 | 0.264 | | |
| 275 | 0.447 | 0.654 | 3.14 | | |
| 284 | 2.66 | 2.16 | 5.15 | | |
| 293 | 5.24 | 4.9 | 6.47 | | |
| 302 | 7.23 | 7.39 | 7.17 | | |
| 320 | 6.93 | 7.25 | 8.03 | | |
| 338 | 8.78 | 9.61 | 9.41 | 0.439 | 0.0754 |
| 356 | | | | 2.38 | 0.0549 |
| 374 | | | | 4.1 | 0.131 |
| 392 | | | | | 2.15 |

(A blank cell indicates that a measurement was not taken.)

### COOKING EXAMPLE

The film of Example 16 was used to form three 12 inch by 18 inch pouches each having three edges heat sealed together using an impulse sealer to seal the edge areas of the first layers of the superimposed sheets together. Raw meat was placed into each pouch through its open forth edge. A 0.5 pound pork tenderloin was placed into the first pouch; and a three pound chicken was placed into each of the second and third pouches. The fourth edge of each pouch was then vacuum heat sealed using a Koch vacuum sealing machine to form three closed packages enclosing the meat.

The first closed pouch was then placed in a microwave oven and cooked on high power for 5 minutes. The first pouch puffed up during cooking. The second closed pouch was placed in the microwave oven and cooked on high power for 20 minutes. The second pouch puffed up during the cooking process and the chicken enclosed in the second pouch became fully cooked and browned on top. The Example 16 film from which the first and second pouches were formed remained clear and flexible. The integrity of the heat seals of each of the first and second pouches were maintained during the microwave oven cooking exposure.

The third closed pouch was placed in a convection oven set at 177° C. (350° F.) for 2 hours. The third pouch puffed up during the cooking process and the chicken became fully cooked and browned on top. The Example 16 film from which the third pouch was formed remained clear and flexible. The integrity of the heat seals of the third closed pouch were maintained during the convection oven cooking exposure.

### EXAMPLES 25-28

The films of Examples 25-28 shown in Table 5 below were made by a blown film extrusion process.

TABLE 5

| | | Thickness | PA1-6 | PA1-6,6 | PA1-6,6/6,10 | PA1-6I/6T | HS | EVOH |
|---|---|---|---|---|---|---|---|---|
| | Layer | (mil) | (wt %) | (wt %) | (wt %) | (wt %) | (wt %) | (wt %) |
| Ex 25 | 1^{st} | 0.5 | 24 | | 75 | | 1 | |
| | 2^{nd} | 1.5 | 40 | 60 | | | | |
| Ex 26 | 1^{st} | 0.5 | 20 | | 59 | 20 | 1 | |
| | 2^{nd} | 1.5 | 40 | 60 | | | | |
| Ex 27 | 1^{st} | 0.5 | 20 | | 59 | 20 | 1 | |
| | 2^{nd} | 1.5 | 69.3 | 30 | | | 0.7 | |
| Ex 28 | 1^{st} | 0.62 | 20 | | 59 | 20 | 1 | |
| | 2^{nd} | 0.45 | 69.3 | 30 | | | 0.7 | |
| | 3rd | 0.29 | | | | | | 100 |
| | 4th | 0.72 | 69.3 | 30 | | | 0.7 | |

Comparative 3 was prepared using a blown film process to make a monolayer film having a thickness of 5 mils and consisting of 100% polypropylene polymer available from Dow Corporation under the Inspire 112 trademark.

Comparative 4 was prepared using a blown film process to make a monolayer film having a thickness of 5 mils and consisting of 100% polypropylene polymer available from Exxon Corporation under the Escorene 7341/NE2 trademark.

Comparative 5 was purchased (available from Reynolds under the Saran Wrap trademark) as a monolayer film having a thickness of about 0.5 mils and consisting of 100% polyvinylidene chloride.

Thirty-five hamburger patties each weighing 0.25 pounds before cooking were uniformly grilled to a well done state.

Pouches were made using each of the films of Examples 25-28 and Comparatives 3-5. Five 12 inch by 18 inch pouches were made for each film of Examples 25-28 and Comparatives 3-4. Each pouch had three edges heat sealed together using an impulse sealer to seal the edge areas of the first layers of the superimposed sheets together. One cooked hamburger patty was placed into each pouch through its open fourth edge. The fourth edge of each pouch was then vacuum heat sealed using a Koch vacuum sealing machine to form vacuum-packed, unperforated, closed packages enclosing the cooked hamburger patty.

The pouches made from Comparatives 3-4 were then further vacuum sealed in a pouch made from Cryovac Series 2000 barrier bag film. Five packages enclosing cooked hamburger patties were also made using the Comparative 5 film by wrapping a hamburger patty in the film.

The packaged cooked hamburger patties were placed into a refrigerator having a temperature of about 4° C. After four days, the packaged cooked hamburger patties were removed from the refrigerator. The unperforated packages made from Examples 25-28 films (and enclosing the cooked hamburger patties) were then placed in a conventional oven having an air temperature of 35° F. for 10 minutes and heated in the unperforated state.

The hamburger patties that had been stored in packages made from Comparatives 3-5 were removed from the packaging and placed on a glass tray, then placed in the conventional oven having an air temperature of 350° F. for 10 minutes. (The cooked hamburger patties were removed from the Comparative 3-5 packages before placement in the oven because the films were not sufficiently temperature stable at the heating conditions.)

A professional taste-testing panel of twenty persons evaluated the reheated cooked meat patties and rated the characteristics of flavor, odor, and overall taste impression using a rating of from 1 to 7 using the following scale: 1=very unacceptable; 2=unacceptable; 3=moderately unacceptable; 4=neither acceptable nor unacceptable; 5=moderately acceptable; 6=acceptable; and 7=very acceptable. The average of the twenty scores for each evaluated characteristic is shown in Table 6.

Five additional hamburger patties each weighing 0.25 pounds before cooking were uniformly grilled to a well done state. These “freshly cooked” patties were not stored by refrigeration, but were evaluated by the taste-testing panel relatively immediately (i.e., upon cooling to approximately the same meat temperature as the reheated patties). The results are also shown in Table 6.

TABLE 6

| | Flavor | Odor | Overall Impression |
|---|---|---|---|
| Example 25 | 5 | 5.2 | 5 |
| Example 26 | 5.4 | 5.2 | 5.4 |
| Example 27 | 5.4 | 5.6 | 5.6 |
| Example 28 | 5 | 6.2 | 5.2 |
| Comparative 3 | 4.6 | 4.6 | 4.4 |
| Comparative 4 | 3 | 3.8 | 2.8 |
| Comparative 5 | 2.8 | 3.8 | 3 |
| Freshly Cooked | 5.6 | 5.6 | 5.6 |

It was unexpected and surprising that the cooked meat that was stored in a refrigerator for four days and then reheated in the unperforated packaging formed of the Examples 25-28 films of the present invention presented flavor, odor, and overall impression characteristics similar to that of the Freshly Cooked meat that had not been refrigerated or stored for any significant amount of time.

### EXAMPLES 29-30

Example 29 film was a monolayer film having a thickness of from about 0.7 to about 0.8 mils, believed to consist of a blend of about 40 weight % nylon-6 and about 60 weight % nylon-6,6, and commercially available from Reynolds Metal Products under the Reynolds Oven Bags trademark.

Example 30 film was a 0.75 mil biaxially oriented polyethylene terephthalate (OPET) film with an amorphous polyester heat seal layer, available from the DuPont Chemical Company under the Teijin Mylar PET film (02/75) trademark.

Eight hamburger patties each weighing 0.25 pounds before cooking were uniformly grilled to a well done state.

Eight pouches of about 4 inches by 8 inches dimension were made using each of the films of Examples 28-30 and Comparative 4-two pouches for each film. (Example 28 and Comparative 4 films are described above.) Each pouch had three edges heat sealed together using an impulse sealer to seal the edge areas of the first layers of the superimposed sheets together. One cooked hamburger patty was placed into each pouch through its open fourth edge. The fourth edge of each pouch was then vacuum heat sealed using a Koch vacuum sealing machine to form vacuum-packed, unperforated, closed packages enclosing the cooked hamburger patty.

The eight packaged cooked hamburger patties were placed into a refrigerator having a temperature of about 4° C. After four days, the packaged cooked hamburger patties were removed from the refrigerator.

One of the unperforated, vacuum-sealed pouches for each of the Examples 28-30 and Comparative 4 films (and containing the cooked meat) were then heated in an unperforated state in a microwave oven by placing the pouches in the oven, activating the oven at high power for 30 seconds, turning the pouches over, again activating the oven at high power for 30 seconds, then turning the pouch over again, and activating the oven at high power for 15 seconds. The meat was then removed from each pouch and taste tested as discussed below.

Separately, one of each of the unperforated, vacuum-sealed pouches for each of the Examples 28-30 and Comparative 4 films were allowed to reach room termperature. Each pouch was then cut open, the cooked meat removed, and a portion of the meat taste tested at room temperature as discussed below. The remaining portions of the removed meat were then placed on a glass tray and reheated in the microwave oven using the same conditions as discussed above.

A professional taste-testing panel evaluated the room temperature and the reheated cooked meat patties and rated the characteristics of flavor and odor using a rating of from 1 to 7 using the following scale: 1=very unacceptable; 2=unacceptable; 3=moderately unacceptable; 4=neither acceptable nor unacceptable; 5=moderately acceptable; 6=acceptable; and 7=very acceptable. The average of the scores for each evaluated characteristic is shown in Table 7.

One additional hamburger patty weighing 0.25 pounds before cooking was uniformly grilled to a well done state. This “freshly cooked” patty was not stored by refrigeration, but was evaluated by the taste-testing panel relatively immediately (i.e., upon cooling to approximately the same meat temperature as the reheated patties). The results are also shown in Table 7.

TABLE 7

| | Flavor | Odor |
|---|---|---|
| Freshly Cooked | 7 | 5 |
| | Not Reheated | |
| Example 28 Pouch | 7 | — |
| Example 29 Pouch | 4 | — |
| Example 30 Pouch | 5 | — |
| Comparative 4 Pouch | 2 | — |
| | Reheated Out of Package | |
| Example 28 Pouch | 5 | 5 |
| Example 29 Pouch | 4 | 4 |
| Example 30 Pouch | 5 | 5 |
| Comparative 4 Pouch | 2 | 1 |
| | Reheated in Unperforated Package | |
| Example 28 Pouch | 7 | 5 |
| Example 29 Pouch | 6 | 4 |
| Example 30 Pouch | 5 | 3 |
| Comparative 4 Pouch | 1 | 1 |

“—” means that the test was not conducted for this sample.

It was unexpected and surprising that the cooked meat that was stored in a pouch made of polyamide (Examples 28-29)—and reheated in the unperforated pouch—flavor tested as acceptable or very acceptable (“6” or “7”) and comparable to the taste of the freshly cooked meat (“7”). It was also unexpected and surprising that the cooked meat that was stored in a pouch made of polyester (Example 30)—and reheated in the unperforated pouch—flavor tasted as moderately acceptable (“5”); while the cooked meat that was stored in a pouch made of polypropylene (Comparative 4) and reheated in the unperforated pouch flavor tested as very unacceptable (“1”).

It was also unexpected and surprising that the cooked meat that was stored in a pouch made of polyamide (Examples 28-29) or polyester (Example 30)—and reheated outside of the pouch—flavor tested at a ranking of “5” or “4” (i.e., moderately acceptable or neutral)—while the cooked meat that was stored in a pouch made of polypropylene (Comparative 4)—and reheated outside of the pouch—flavor tested at a ranking of “2” (i.e., unacceptable).

It was also unexpected and surprising that even without reheating, the cooked meat that was stored in a pouch made of polyamide (Examples 28-29) or polyester (Example 30) would flavor test as neutral (“4”) or better (i.e., “5” or “7”); whereas, the cooked meat that was stored in a pouch made of polypropylene (Comparative 4) flavor tested as unacceptable (“2”).

The above descriptions are those of preferred embodiments of the invention. Various alterations and changes can be made without departing from the spirit and broader aspects of the invention as defined in the claims, which are to be interpreted in accordance with the principles of patent law, including the doctrine of equivalents. Except in the claims and the specific examples, or where otherwise expressly indicated, all numerical quantities in this description indicating amounts of material, reaction conditions, use conditions, molecular weights, and/or number of carbon atoms, and the like, are to be understood as modified by the word “about” in describing the broadest scope of the invention. Any reference to an item in the disclosure or to an element in the claim in the singular using the articles “a,” “an,” “the,” or “said” is not to be construed as limiting the item or element to the singular unless expressly so stated. All references to ASTM tests are to the most recent, currently approved, and published version of the ASTM test identified, as of the priority filing date of this application. Each such published ASTM test method is incorporated herein in its entirety by this reference.

What is claimed is:

1. A method of preparing food comprising the following steps:
providing an unperforated package defining an internal space inside the package wherein:
the internal space has a pressure of less than about 13.7 psia;
a cooked meat is in the internal space of the package, the cooked meat having an internal meat temperature of less than about 100° F.; and
the package comprises a film comprising an inside film layer adjacent the internal space of the package, wherein the inside film layer comprises one or more polymers selected from polyamide and polyester; and
subsequently heating the cooked meat in the internal space of the package to an internal meat temperature of above about 100° F. while the package is in the unperforated state.

2. The method of claim 1 wherein the inside film layer comprises less than about 20 weight % polyolefin by weight of the inside film layer.

3. The method of claim 1 wherein the inside film layer is substantially free of polyolefin.

4. The method of claim 1 wherein the film comprises less than about 20 weight % polyolefin by weight of the film.

5. The method of claim 1 wherein the film is substantially free of polyolefin.

6. The method of claim 1 wherein the inside film layer comprises polyamide.

7. The method of claim 1 wherein the inside film layer comprises at least about 70 weight percent polyamide by weight of the inside film layer.

8. The method of claim 1 wherein the inside film layer comprises at least about 90 weight percent polyamide by weight of the inside film layer.

9. The method of claim 1 wherein the inside film layer consists essentially of polyamide.

10. The method of claim 1 wherein the film comprises at least about 70 weight percent polyamide by weight of the film.

11. The method of claim 1 wherein the film comprises at least about 90 weight percent polyamide by weight of the film.

12. The method of claim 1 wherein the film layer consists essentially of polyamide.

13. The method of claim 1 wherein the package comprises at least about 70 weight percent polyamide by weight of the package.

14. The method of claim 1 wherein the package comprises at least about 90 weight percent polyamide by weight of the package.

15. The method of claim 1 wherein the package consists essentially of polyamide.

16. The method of claim 1 wherein the inside film layer comprises polyester.

17. The method of claim 1 wherein the inside film layer comprises at least about 70 weight percent polyester by weight of the inside film layer.

18. The method of claim 1 wherein the inside film layer comprises at least about 90 weight percent polyester by weight of the inside film layer.

19. The method of claim 1 wherein the inside film layer consists essentially of polyester.

20. The method of claim 1 wherein the film comprises at least about 70 weight percent polyester by weight of the film.

21. The method of claim 1 wherein the film comprises at least about 90 weight percent polyester by weight of the film.

22. The method of claim 1 wherein the film consists essentially of polyester.

23. The method of claim 1 wherein the package comprises at least about 70 weight percent polyester by weight of the package.

24. The method of claim 1 wherein the package comprises at least about 90 weight percent polyester by weight of the package.

25. The method of claim 1 wherein the package consists essentially of polyester.

26. The method of claim 1 wherein the film comprises less than about 20% polyester by weight of the film.

27. The method of claim 1 wherein the film is substantially free of polyester.

28. The method of claim 1 wherein the package consists essentially of the film.

29. The method of claim 1 wherein the film is monolayer.

30. The method of claim 1 wherein the heating step comprises heating the cooked meat in the internal space of the package to an internal meat temperature of above about 130° F. while the package is in the unperforated state.

31. The method of claim 1 wherein the heating step comprises heating the cooked meat in an oven having an air temperature of at least about 250° F.

32. The method of claim 1 wherein the heating step comprises heating the cooked meat in an oven having an air temperature of at least about 300° F.

33. The method of claim 1 wherein the heating step comprises heating the cooked meat in an oven having an air temperature of at least about 325° F.

34. The method of claim 1 wherein the heating step comprises heating the cooked meat in an oven having an air temperature of at least about 350° F.

35. The method of claim 1 wherein the heating step comprises heating the cooked meat in an oven having an air temperature of at least about 375° F.

36. The method of claim 1 wherein the heating step comprises heating the cooked meat in an oven having an air temperature of at least about 400° F.

37. The method of claim 1 wherein the heating step comprises heating the cooked meat in a microwave oven.

38. The method of claim 1 wherein the heating step comprises placing the unperforated package in a heated liquid.

39. The method of claim 1 wherein the pressure of the internal space of the provided package is less than about 12 psia.

40. The method of claim 1 wherein the pressure of the internal space of the provided package is less than about 3 psia.

41. The method of claim 1 wherein the internal meat temperature of the cooked meat of the provided package is less than about 60° F.

42. The method of claim 1 wherein the internal meat temperature of the cooked meat of the provided package is less than about 40° F.

43. The method of claim 1 wherein the internal meat temperature of the cooked meat of the provided package is less than about 32° F.

44. The method of claim 1 further comprising a step of storing the cooked meat in the unperforated package for at least two days before the heating step.

45. The method of claim 1 further comprising a step of storing the cooked meat in the unperforated package for at least four days before the heating step.

46. The method of claim 1 further comprising a step of storing the cooked meat at an internal meat temperature of less than about 45° F. in the unperforated package for at least four days before the heating step.

47. The method of claim 1 further comprising a step of storing the cooked meat at an internal meat temperature of less than about 45° F. in the unperforated package for at least six days before the heating step.

48. The method of claim 1 wherein the cooked meat comprises red meat.

49. The method of claim 1 wherein the cooked meat comprises ground hamburger.

50. The method of claim 1 wherein:
the inside layer of the film comprises one or more polyamides;
the inside layer of the film has a melting point;
the film further comprises a second layer comprising one or more polyamides;
the second layer has a melting point of at least about 210° C.; and
the melting point of the second layer of the film is at least about 20° F. greater than the melting point of the inside layer of the film.

51. The method of claim 50 wherein the inside film layer comprises at least 20% amorphous polyamide by weight of the inside film layer.

52. The method of claim 50 wherein the inside film layer comprises less than about 50% of the total thickness of the film.

53. The method of claim 50 wherein the inside film layer comprises at least 70% by weight of the inside film layer of a blend comprising one or more polyamides having a melting point of at least about 210° C. and one or more polyamides having a melting point of less than about 210° C.

54. The method of claim 53 wherein the blend comprises at least about 50% by weight of the blend of the one or more polyamides having a melting point of less than about 210° C.

55. The method of claim 1 wherein the inside film layer comprises at least two polyamides.

56. The method of claim 1 wherein:
the inside layer of the film comprises one or more polyamides;
the inside layer has a glass transition temperature of less than about 120° C. measured at a 50% relative humidity;
the film further comprises a second layer comprising one or more polyamides; and
the second layer has a melting point of at least about 210° C.

57. The method of claim 1 wherein:
the inside layer of the film comprises one or more polyamides;
the film further comprises a second layer comprising one or more polyamides;
the second layer has a melting point of at least about 210° C.; and
the film is capable of forming a water-containing package by providing two 4 inch by 6 inch sheets of the film each having four perimeter sides, placing the sheets in superimposed, coextensive arrangement having the inside film layers of the films in contact with each other, heat sealing three perimeter sides of the sheets together using a ⅛-inch wide sealing bar at a temperature of 290° F., a dwell time of 0.5 seconds, and a sealing pressure of 40 psig to form an open pouch having heat seals along three of the four perimeter sides, filling the open pouch with 100 milliliters of distilled water at a temperature of 73° F., heat sealing the fourth perimeter sides of the sheets together under the same conditions as used to seal the three perimeter sides to form a closed container having a heat seal along the fourth perimeter side and containing the water, where the seal strength of the heat seals is at least 1 pound/inch after the closed, water-containing container has been exposed to three hours in a conventional oven at 400° F. (air temperature).

58. The method of claim 57 wherein the inside film layer comprises two or more polyamides selected from nylon-6, nylon-6,6, nylon-6,6/6,10, nylon-6,12, and nylon-6/6,6.

59. The method of claim 57 wherein the inside film layer comprises nylon-6, nylon-6,6/6,10, and nylon-6/6,6.

60. The method of claim 57 wherein the second layer of the film comprises at least about 50% of the total thickness of the film.

61. The method of claim 57 wherein the second layer of the film comprises at least about 80% of one or more polyamides by weight of the second layer.

62. The method of claim 57 wherein the second layer of the film comprises one or more polyamides selected from nylon-6, nylon-6,6, and nylon-6/6,6.

63. The method of claim 57 wherein the second layer of the film forms an outer surface of the film.

64. The method of claim 57 wherein the film comprises a third layer comprising ethylene/vinyl alcohol copolymer.

65. The method of claim 57 wherein the melting point of the inside film layer is less than about 220° C.

66. The method of claim 57 wherein the film has an oxygen transmission rate of no more than about 150 cubic centimeters (at standard temperature and pressure) per square meter per day per 1 atmosphere of oxygen pressure differential measured at 0% relative humidity and 23° C.
